(19) United States
(12) Patent Application Publication
(10) Pub. No.: US 2023/0349548 A1
(43) Pub. Date: Nov. 2, 2023

(54) CHEMICAL LOOPING COMBUSTION AND CARBON DIOXIDE DIRECT REDUCTION (CLC-CDR) INTEGRATION SYSTEM AND OPERATION METHOD THEREOF

(71) Applicant: KOREA INSTITUTE OF ENERGY RESEARCH, Daejeon (KR)

(72) Inventors: Ho-Jung RYU, Daejeon (KR); Byung Wook HWANG, Daejeon (KR); Hana KIM, Daejeon (KR); Yooseob WON, Daejeon (KR); Daewook KIM, Daejeon (KR); Yu Ri LEE, Daejeon (KR); Sung-Ho JO, Daejeon (KR); Seung-Yong LEE, Daejeon (KR); Young Cheol PARK, Daejeon (KR)

(73) Assignee: KOREA INSTITUTE OF ENERGY RESEARCH, Daejeon (KR)

(21) Appl. No.: 18/176,167

(22) Filed: Feb. 28, 2023

(30) Foreign Application Priority Data
Apr. 29, 2022 (KR) 10-2022-0053414

(51) Int. Cl. F23C 10/04; F23C 10/01; F23C 10/22

(52) U.S. Cl. CPC F23C 10/04; F23C 10/01; F23C 10/22; F23C 2900/99008

(57) ABSTRACT

The present invention relates to a chemical looping combustion and carbon dioxide direct reduction (CLC-CDR) integration system and an operation method thereof, particularly to a chemical looping combustion and carbon dioxide direct reduction (CLC-CDR) integration system including: an air reactor, wherein an oxygen carrier particle is oxidized by reacting with injected air and air from which oxygen was partially removed is discharged; a fuel reactor, wherein the oxidized oxygen carrier particle is supplied, a supplied fuel is reacted to reduce the oxidized oxygen carrier particle, and carbon dioxide including H₂O is discharged; and a carbon dioxide reduction reactor, wherein the reduced oxygen carrier particle is supplied, supplied carbon dioxide is reacted to discharge carbon monoxide, and the reduced oxygen carrier particle is partially oxidized and supplied to the air reactor.

### CROSS-REFERENCE TO RELATED APPLICATIONS

This application claims priority to and the benefit of Korea Patent Application No. 10-2022-0053414 filed in the Korean Intellectual Property Office on Apr. 29, 2022, the contents of which are incorporated herein by reference in their entirety.

### BACKGROUND

### Technical Field

The present disclosure is related to a chemical looping combustion and carbon dioxide direct reduction (CLC-CDR) integration system and an operation method thereof.

### Related Art

The demand for liquefied natural gas (LNG) power generation that allows reducing greenhouse gas (GHG) emissions is increasing in accordance with the carbon neutrality master plan and the LNG power generation expansion policy of the government of the republic of Korea. In order to meet the aforesaid demand and to reduce the cost for reducing CO₂ emissions, the research and development for chemical looping combustion technology is ongoing as the next-generation technology of LNG power generation.

The chemical looping combustion technology is a technology with inherent separation of CO₂ generated during the combustion process without any additional CO₂ capture process. FIG. 1 shows a conceptual diagram of a chemical looping combustion system. As shown in FIG. 1, using metal oxides that can give and receive oxygen as an oxygen carrier material, in one reactor (air reactor), an oxygen carrier particle absorbs oxygen included in air to form metal oxide. The metal oxide is transported to another reactor (fuel reactor), reacting with a fuel to release oxygen and to be reduced into a metal form, and then being recycled to the air reactor and oxidized again to play a role in delivering oxygen in air injected into the air reactor to the fuel reactor.

In the air reactor, as seen in following Formula (1), a metal particle (M) is reacted with oxygen in air to form a metal oxide (MO), wherein a gas to be injected is air and a gas to be discharged is air in which oxygen was consumed.

Air Reactor (Oxidation Reaction)

2MₓO_{y-1}+O₂→2MₓO_{y} (1)

On the other hands, in the fuel reactor, as seen in following Formula (2), as the metal oxide (M) comes in contact with a gaseous fuel (CH₄, H₂, CO, CₙH₂ₘ), oxygen included in an oxygen carrier particle is reacted with a fuel, the metal oxide (MO) is reduced into a metal (M) and the gaseous fuel is reacted with oxygen received from the oxygen carrier particle to generate CO₂ and H₂O only.

Fuel Reactor (Reduction Reaction)

(2n+m)MₓO_{y}+CₙH₂ₘ→(2n+m)MₓO_{y-1}+mH₂O+nCO₂ (2)

As a result, since a gas to be injected to the fuel reactor is a fuel and gases to be discharged are only CO₂ and H₂O, a high concentration of CO₂ can be inherently separated without any additional CO₂ capturer process by condensing and removing H₂O. Further, the oxidation reaction of the oxygen carrier particle occurring in the air reactor is a gas-solid reaction. This reaction occurs under a flame-free condition, allowing minimizing generation of thermal-NOx.

Due to the aforementioned advantageous effects, studies on the application of a chemical looping combustion system to fuels such as coal, syngas, methane, LNG and the like are ongoing. In order for the application to a natural gas combined cycle (NGCC) system, a study for the development of a high-pressure chemical looping combustion system that can be driven along with a steam turbine and a gas turbine had also been conducted.

In the light of the application of a chemical looping combustion system to an LNG combustion-power generation system, CH₄, that is, a main component of LNG is considered as a fuel. When using a NiO based particle as a main component of oxygen carrier particle, the oxidation reaction of formula (1) and the reduction reaction of formula (2) can be represented by reaction formulas as seen in following Formula (3) and Formula (4), respectively, wherein the oxidation reaction occurring in the air reactor is an exothermic reaction, whereas the reduction reaction occurring in the fuel reactor is an endothermic reaction.

Air Reactor (Oxidation Reaction): Exothermic Reaction

2Ni+O₂→2NiO (ΔH=−481.16 kJ/mol) (3)

Fuel Reactor (Reduction Reaction): Endothermic Reaction

CH₄+4NiO→4Ni+CO₂+2H₂O (ΔH=160.01 kJ/mol) (4)

Meanwhile, typical combustion of CH₄ by oxygen is as seen in following formula (5), becoming equal to Formula (3)×2+Formula (4).

Combustion of CH₄: Exothermic reaction

CH₄+2O₂→CO₂₊₂H₂O (ΔH=−802.31 kJ/mol) (5)

As a result, as considering the exothermic amount through the oxidation reaction and the endothermic amount through the reduction reaction together in the chemical looping combustion system, these become equal to the exothermic amount resulting from the combustion of CH₄.

As condensing and removing steam (H₂O) from the gas discharged from the fuel reactor of the chemical looping combustion system, a high concentration of CO₂ that is inherently separated can be stored underground for carbon emission reduction or otherwise converted into a useful material for utilization.

Further, a reverse water gas shift (RWGS) reaction is representative of conversion technology for utilization of CO₂, obtaining CO and H₂O by reacting CO₂ and hydrogen as seen in following Formula (6). CO is widely used as an intermediate for preparing various kinds of chemicals.

When a conversion rate of the RWGS reaction is low, discharging a reactant and a resulting product together, discharged gases may include CO₂, H₂, CO and H₂O, and there is a drawback, that is, a high cost for separating a desired gas among these gases.

RWGS Reaction: Endothermic Reaction

CO₂+H₂→CO+H₂O ΔH⁰₂₉₈=41.1 kJ (6)

FIG. 2 shows a conceptual diagram of reverse water gas shift (RWGS) technology. As a method to overcome the aforesaid drawback, as shown in FIG. 2, reverse water gas shift with chemical looping (RWGS-CL) technology may be used, which occurs the RWGS reaction of Formula (6) as two separate reactions by using a metal (M)-metal oxide (MO) form of oxygen carrier particle similarly to the chemical looping combustion.

According to RWGS-CL technology, in a hydrogen-oxidation reactor, as seen in following Formula (7), H₂O is generated by oxidation reaction of hydrogen, causing a reduction reaction of metal oxide. In a CO₂ reduction reactor, as seen in following Formula (8), CO is generated by a reduction reaction of CO₂, causing an oxidation reaction of the metal oxide. An oxygen carrier particle that carries oxygen circulates between two separate reactors.

Hydrogen-Oxidation Reactor

MₓO_{y}+H₂→MₓO_{y-1}+H₂O (7)

CO₂ Reduction Reactor

MₓO_{y-1}+CO₂→MₓO_{y}+CO (8)

As using RWGS-CL technology, as shown in Formula (7), in the hydrogen-oxidation reactor, only unreacted H₂ and a reaction product, steam (H₂O) are generated. Thus, hydrogen can be separated at a low cost because a high concentration of hydrogen can be obtained by condensing and removing the steam, and there is an advantageous effect that separated hydrogen can circulate to the hydrogen-oxidation reactor and then re-used. Further, as shown in Formula (8), gases discharged from the CO₂ reduction reactor includes only unreacted CO₂ and reaction product, CO. Thus, as compared to when CO₂, H₂, CO and H₂O are discharged together, CO and CO₂ are easily separated, and a (CO+CO₂) composite gas may be used in synthesis reactions such as methanol synthesis and the like.

In order to take account of reaction heat in each reaction according to RWGS-CL technology, as allowing for using a Ni based particle as an oxygen carrier particle in reactions of Formula (7) and Formula (8), as seen in following formula (9), in the hydrogen-oxidation reactor, NiO and hydrogen are reacted to generate Ni and H₂O, while, in the CO₂ reduction reactor, CO₂ and Ni are reacted to generate CO and Ni is oxidized to NiO. Thus, these may be re-used in the hydrogen-oxidation reactor. Meanwhile, the reaction according to following Formula (9) occurring in the hydrogen-oxidation reactor is a weak exothermic reaction, while the reaction according to following Formula (10) occurring in the CO₂ reduction reactor is an endothermic reaction. Thus, an additional energy supply is required. That is, there is a drawback that RWGS-CL technology according to Formula (9) and Formula (10) requires hydrogen to reduce metal oxides and an additional energy supply during the reduction of CO₂ into CO.

Hydrogen-Oxidation Reactor: Weak Exothermic Reaction

NiO+H₂→Ni+H₂O ΔH⁰₂₉₈=−2.1 kJ (9)

CO₂ Reduction Reactor: Endothermic Reaction

Ni+CO₂→NiO+CO ΔH⁰₂₉₈=43.2 kJ (10)

As considering Formula (9) and Formula (10) together (Formula (9)+Formula (10)), the whole reaction equation is the same as the RWGS reaction as shown in Formula (6) and is an endothermic reaction.

Meanwhile, allowing for using a Fe based particle as an oxygen carrier particle instead of the Ni based particle, all reactions occurring in the hydrogen-oxidation reactor and the CO₂ reduction reactor, as seen in following Formula (11) and Formula (12) respectively, are endothermic reactions and, in this case, an additional energy supply is required in both of the reactors.

Hydrogen-Oxidation Reactor: Endothermic Reaction

FeO+H₂→Fe+H₂O ΔH⁰₂₉8=25.5 kJ (11)

CO₂ Reduction Reactor: Endothermic Reactor

Fe+CO₂→FeO+CO ΔH⁰₂₉8=15.6 kJ (12)

In order to reduce CO₂ in RWGS reaction equation (6), a hydrogen-oxidation reaction (Formula (7)) has a drawback requiring high-priced hydrogen for reducing metal oxide.

Further, in order to maintain the RWGS reaction, it is necessary to supply energy from the outside, and in the case of RWGS-CL technology, in order to maintain a CO₂ reduction reaction, it is necessary to supply energy from the outside. Thus, when using fossil energy during the energy supply, additional CO₂ may be discharged.

### RELATED ART DOCUMENT

### Patent Document

(Patent Document 1) Korean Patent No. 10-1831348
(Patent Document 2) Japanese Patent No. JP 6214344
(Patent Document 3) Korean Patent No. 10-1992635
(Patent Document 4) Japanese Laid-open publication No. JP 2019-52805

### SUMMARY

### Technical Problem

Therefore, the present disclosure is provided to overcome conventional problems as described above. According to the embodiment of the present disclosure, on the contrary to chemical looping combustion technology wherein CO₂ is discharged and thus additionally requires storing or converting technology of CO₂, it is aimed to provide a chemical looping combustion and carbon dioxide direct reduction (CLC-CDR) integration system and an operation method thereof, wherein a useful material, CO may be obtained, while producing steam and electricity, as applying carbon dioxide direct reduction technology; CH₄ may be used as a reducing agent instead of high priced hydrogen, being economical; air in which oxygen was consumed may be discharged from an air reactor; a high concentration of CO₂ may be inherently separated in a fuel reactor; and unreacted CO₂ and a reaction product, CO may be discharged from a CO₂ reduction reactor, allowing separating a resulting product at low cost as compared to RWGS reaction.

Further, according to the embodiment of the present disclosure, it is aimed to provide a chemical looping combustion and carbon dioxide direct reduction (CLC-CDR) integration system and an operation method thereof, wherein since the whole reaction is an exothermic reaction, CO may be generated from a discharged gas while generating steam and electricity by using a high temperature of gas discharged from an air reactor.

In addition, according to an embodiment of the present disclosure, it is aimed to provide a chemical looping combustion and carbon dioxide direct reduction (CLC-CDR) integration system and an operation method thereof, wherein a ratio of CO and CO₂ that are required in a downstream process may be controlled in a manner of mixing a part of CO₂ discharged from a fuel reactor with a discharged gas of a CO₂ reduction reactor.

Further, according to an embodiment of the present disclosure, it is aimed to provide a chemical looping combustion and carbon dioxide direct reduction (CLC-CDR) integration system and an operation method thereof, wherein since a CO₂ reduction reactor is of an endothermic reaction, energy required in the CO₂ reduction reactor may be supplied by using, as a heat exchange fluid, a high temperature of gas discharged from an air reactor that is of an exothermic reaction, thus involving no additional discharging of CO₂ during the energy supply to the CO₂ reduction reactor.

In addition, according to the present disclosure, it is aimed to provide a chemical looping combustion and carbon dioxide direct reduction (CLC-CDR) integration system and an operation method thereof, wherein an oxidation-reduction state of an oxygen carrier particle may be controlled by recycling a gas discharged from an air reactor and using the recycled gas instead pure air, or mixing it with pure air and using a mixture thereof. Further, when recycling the gas discharged from the air reactor as the above to the air reactor, the temperature thereof is higher than that of air in the atmosphere, thus enhancing thermal efficiency of the air reactor.

Meanwhile, technical objects to be achieved in the present invention are not limited to the aforementioned technical objects, and other technical objects, which are not mentioned above, will be apparently understood to a person having ordinary skill in the art from the following description.

### Technical Solution

A first aspect of the present disclosure relates to a chemical looping combustion and carbon dioxide direct reduction (CLC-CDR) integration system which may include: an air reactor, wherein an oxygen carrier particle is oxidized by reacting with injected air and air from which oxygen was partially removed is discharged; a fuel reactor, wherein the oxidized oxygen carrier particle is supplied, a supplied fuel is reacted to reduce the oxidized oxygen carrier particle, and carbon dioxide including H₂O is discharged; and a carbon dioxide reduction reactor, wherein the reduced oxygen carrier particle is supplied, supplied carbon dioxide is reacted to discharge carbon monoxide, and the reduced oxygen carrier particle is partially oxidized and supplied to the air reactor.

In addition, the chemical looping combustion and carbon dioxide direct reduction (CLC-CDR) integration system which may include a carbon dioxide supply line that connects an outlet portion of the fuel reactor and the carbon dioxide reduction reactor, wherein carbon dioxide supplied to the carbon dioxide reduction reactor is one in which H₂O was removed from a gas discharged from the fuel reactor.

Further, another aspect of the present disclosure relates to the chemical looping combustion and carbon dioxide direct reduction (CLC-CDR) integration system, wherein the air reactor may be of an exothermic reaction (oxidizer), the fuel reactor may be of an endothermic reaction (reducer), the carbon dioxide reduction reactor may be of an endothermic reaction and the whole system may be of an exothermic reaction, and steam or electricity may be generated by a heat discharged from the air reactor.

In addition, the chemical looping combustion and carbon dioxide direct reduction (CLC-CDR) integration system may include a first bypass line that is connected in-between one side of the carbon dioxide supply line and a discharge portion of the carbon dioxide reduction reactor, wherein a ratio of carbon monoxide and carbon dioxide required for a downstream process is controlled by mixing a part of carbon dioxide discharged from the fuel reactor with a gas discharged from the carbon dioxide reduction reactor.

Further another aspect of the present disclosure relates to the chemical looping combustion and carbon dioxide direct reduction (CLC-CDR) integration system which may further include a heat exchanger that heats the carbon dioxide reduction reactor by using a heat of a gas discharged from the air reactor as a heat source.

In addition, the chemical looping combustion and carbon dioxide direct reduction (CLC-CDR) integration system which may include a second bypass line that connects between a rear end of the heat exchanger and an air injection portion of the air reactor, wherein a gas discharged from the air reactor is supplied to the air injection portion of the air reactor.

Further, another aspect of the present disclosure relates to the chemical looping combustion and carbon dioxide direct reduction (CLC-CDR) integration system, wherein a mixing ratio of air and a gas discharged from the air reactor may be adjusted to control an oxidation-reduction state of the oxygen carrier particle.

A second aspect of the present disclosure relates to an operation method of a chemical looping combustion and carbon dioxide direct reduction (CLC-CDR) integration system which may include steps of: reacting air injected into an air reactor and an oxygen carrier particle to oxidize the oxygen carrier particle, and discharging air from which oxygen was partially removed; supplying the oxidized oxygen carrier particle to a fuel reactor, reacting a supplied fuel to reduce the oxidized oxygen carrier particle, and discharging carbon dioxide including H₂O; and supplying the reduced oxygen carrier particle to a carbon dioxide-reactor, supplying carbon dioxide in which H₂O was removed from a gas discharged from the fuel reactor to discharge carbon monoxide, and partially oxidizing the reduced oxygen carrier particle to be supplied to the air reactor.

In addition, the operation method of a chemical looping combustion and carbon dioxide direct reduction (CLC-CDR) integration system may further include a step of generating steam or electricity by a heat discharged from the air reactor.

Further, another aspect of the present disclosure relates to the operation method of a chemical looping combustion and carbon dioxide direct reduction (CLC-CDR) integration system may further include a step of mixing a part of carbon dioxide that is discharged from the fuel reactor through a first bypass line connected in-between one side of a carbon dioxide supply line and a discharge portion of a carbon dioxide reduction reactor, with a gas discharged from the carbon dioxide reduction reactor, to control a ratio of carbon monoxide and carbon dioxide required for a downstream process.

In addition, the operation method of a chemical looping combustion and carbon dioxide direct reduction (CLC-CDR) integration system may further include a step of supplying a gas discharged from the air reactor to a heat exchanger fitted to the carbon dioxide reduction reactor to heat the carbon dioxide reduction reactor.

Further, another aspect of the present disclosure relates to the operation method of a chemical looping combustion and carbon dioxide direct reduction (CLC-CDR) integration system may further include a step of supplying a gas discharged from the air reactor to an air injection portion of the air reactor through a second bypass line that connects between a rear end of the heat exchanger and the air injection portion of the air reactor.

Further, another aspect of the present disclosure related to the operation method of a chemical looping combustion and carbon dioxide direct reduction (CLC-CDR) integration system, wherein a mixing ratio of air and a gas discharged from the air reactor is adjusted to control an oxidation-reduction state of the oxygen carrier particle.

### Advantageous Effects

According to a chemical looping combustion and carbon dioxide direct reduction (CLC-CDR) integration system and an operation method thereof in accordance of the embodiment of the present disclosure, on the contrary to chemical looping combustion technology wherein CO₂ is discharged and thus additionally requires storing or converting technology of CO₂, it is capable of obtaining a useful material, CO, while producing steam and electricity, as applying carbon dioxide direct reduction technology, being economical as using CH₄ as a reducing agent instead of high priced hydrogen, discharging air in which oxygen was consumed from an air reactor, and inherently separating a high concentration of CO₂ in a CO₂ reduction reactor, and discharging unreacted CO₂ and a reaction product, CO from a CO₂ reduction reactor, allowing separating a resulting product at low cost as compared to RWGS reaction.

Further, according to a chemical looping combustion and carbon dioxide direct reduction (CLC-CDR) integration system and an operation method thereof in accordance of the embodiment of the present disclosure, since the whole reaction is an exothermic reaction, it is capable of generating CO from the discharged gas while generating steam and electricity by using a high temperature of gas discharged from an air reactor.

In addition, according to a chemical looping combustion and carbon dioxide direct reduction (CLC-CDR) integration system and an operation method thereof in accordance of the embodiment of the present disclosure, it is capable of controlling a ratio of CO and CO₂ that are required in the downstream process in a manner of mixing a part of CO₂ discharged from a fuel reactor with a discharged gas of a CO₂ reduction reactor.

Further, according to a chemical looping combustion and carbon dioxide direct reduction (CLC-CDR) integration system and an operation method thereof in accordance of the embodiment of the present disclosure, since a CO₂ reduction reactor is of an endothermic reaction, energy required in the CO₂ reduction reactor may be supplied by using, as a heat exchange fluid, a high temperature of gas discharged from an air reactor that is of an exothermic reaction. Thus, it is capable of involving no additional discharging of CO₂ during the energy supply to the CO₂ reduction reactor.

In addition, according to a chemical looping combustion and carbon dioxide direct reduction (CLC-CDR) integration system and an operation method thereof in accordance of the embodiment of the present disclosure, it is capable of controlling an oxidation-reduction state of an oxygen carrier particle by recycling a gas discharged from an air reactor and using the recycled gas instead pure air, or mixing it with pure air and using a mixture thereof. Further, when recycling the gas discharged from the air reactor as the above to the air reactor, since the temperature thereof is higher than that of air in the atmosphere, it is capable of enhancing thermal efficiency of the air reactor.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings.

FIG. 1 is a conceptual diagram of a chemical looping combustion system.

FIG. 2 is a conceptual diagram of chemical looping reverse water gas shift (RWGS-CL) technology.

FIG. 3 is a conceptual diagram of a chemical looping combustion and carbon dioxide direct reduction (CLC-CDR) integration system according to an embodiment of the present disclosure.

FIG. 4 is a flowchart of an operation method of a chemical looping combustion and carbon dioxide direct reduction (CLC-CDR) integration system according to an embodiment of the present disclosure.

FIG. 5 is a conceptual diagram of a chemical looping combustion and carbon dioxide direct reduction (CLC-CDR) integration system showing control functions according to an embodiment of the present disclosure.

### DETAILED DESCRIPTION

Hereinafter, the aforementioned aims, other aims, features and advantageous effects of the present disclosure will be understood easily referring to preferable embodiments related to the accompanying drawings. However, the present disclosure is not limited to embodiments described in this specification, and may be embodied into other forms. Preferably, the embodiments in this specification are provided in order to allow disclosed contents to be exhaustive and to communicate the concept of the present disclosure to those skilled in the art. In this specification, when a certain element is placed on another element, this means that it may be formed directly thereon or that the third element may be interposed between them. Further, in the drawings, the thickness of an element may be overstated in order to explain the technical content thereof efficiently.

The embodiments described in this specification will explained with reference to a cross-sectional view and/or a plane view. In the drawings, the thickness of a film and a region may be overstated in order to explain the technical content thereof efficiently. Accordingly, the form of exemplary drawings for a fabrication method and/or an allowable error et cetera may be modified. Thus, the embodiments according to the present disclosure are not limited to specific forms illustrated herein, but may include variations in the form resulting from the fabrication method. For example, the region illustrated with perpendicular lines may have a form to be rounded or with a predetermined curvature. Thus, regions exemplified in the drawings have attributes, and shapes thereof exemplify specific forms rather than limiting the scope of the present disclosure. In the various embodiments of this specification, terms such as ‘first’ and ‘second’ et cetera are used to describe various elements, but these elements should not be limited to such terms. These terms are merely used to distinguish one element from others. The embodiments explained and exemplified herein may include complementary embodiments thereto.

The terms used in this specification is to explain the embodiments rather than limiting the present disclosure. In this specification, the singular expression includes the plural expression unless specifically stated otherwise. The terms, such as ‘comprise” and/or “comprising” do not preclude the potential existences of one or more elements.

When describing the following specific embodiments, various kinds of specific contents are made up to explain the present disclosure in detail and to help understanding thereof. However, it will be apparent for those who have knowledge to the extent of understanding the present disclosure that the present disclosure can be used without any of these specific contents. In a certain case when describing the present disclosure, the content that is commonly known to the public but is largely irrelevant to the present disclosure is not described in order to avoid confusion.

Hereinafter, configurations and functions of a chemical looping combustion and carbon dioxide direct reduction (CLC-CDR) system and an operation method thereof will be described.

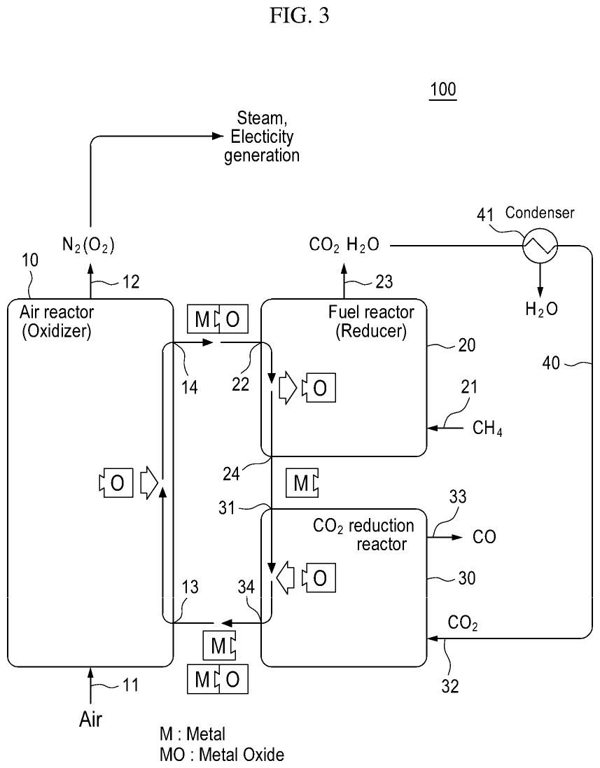

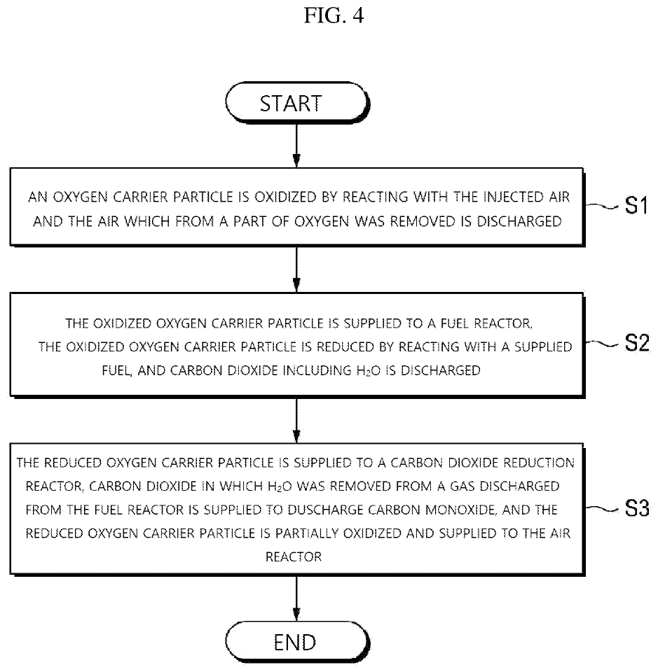

FIG. 3 is a conceptual diagram of a chemical looping combustion and carbon dioxide direct reduction (CLC-CDR) integration system according to an embodiment of the present disclosure. FIG. 4 is a flowchart of an operation method of a chemical looping combustion and carbon dioxide direct reduction (CLC-CDR) integration system according to an embodiment of the present disclosure.

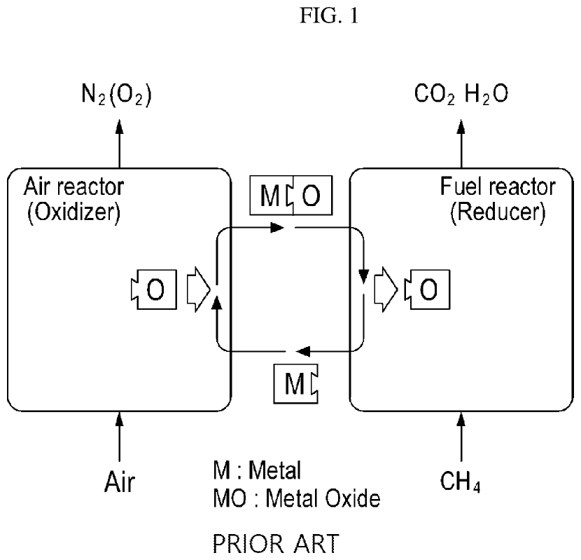

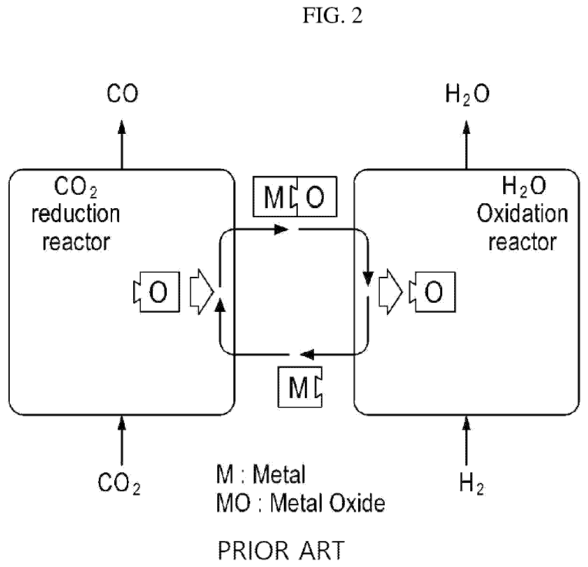

FIG. 3 shows a chemical looping combustion and carbon dioxide direct reduction (CLC-CDR) integration system according to an embodiment of the present disclosure, which is characterized in that chemical looping combustion combined with the aforementioned, chemical looping combustion technology as shown in FIG. 1 and RWGS-CL technology as shown in FIG. 2 is closely combined with CO₂ direct reduction (CLC-CDR, Chemical Looping Combustion) technology.

FIG. 3 is of a chemical looping combustion and carbon dioxide direct reduction (CLC-CDR) integration system according to an embodiment of the present disclosure, and it is seen that the system is, in general, configured to include an air reactor, a fuel reactor and a carbon dioxide reduction reactor.

An air reactor 10 includes an air injection portion 11 for injecting air, a gas discharge portion 12 for discharging a discharge gas, an oxygen carrier particle supply portion 13 for supplying an oxygen carrier particle, and an oxygen carrier particle outlet portion 14 for discharging an oxidized oxygen carrier particle. Herein, the oxygen carrier particle is oxidized by reacting with injected air, and air in which oxygen was partially removed is discharged (S1).

As taking an example allowing for using a Ni based particle as an oxygen carrier particle and methane (CH₄) as a fuel in order to take account of a reaction heat in the whole reaction, in the air reactor 10, as seen in following Formula (13), oxygen in air and a metal (Ni) are reacted to generate a metal oxide (NiO) and a heat is released during this process.

Air Reactor: Exothermic Reaction

3Ni+1.5O₂→3NiO ΔH⁰₂₉₈=−719.1 kJ (13)

In addition, a fuel reactor 20 is configured to include a fuel supply portion 21 for supplying a fuel, an oxygen carrier particle inlet portion 22 for inletting an oxygen carrier particle, an outlet portion for discharging a discharge gas and an oxygen carrier particle discharge portion 24. In the fuel reactor, an oxidized oxygen carrier particle is supplied and reacted with a supplied fuel to reduce the oxidized oxygen carrier particle and carbon dioxide including H₂O is discharged (S2).

That is, the oxygen carrier particle oxidized by air is moved to the fuel reactor 20 and reacted with methane (CH₄) as seen in following Formula (14) to generate CO₂ and H₂O. Generated steam is condensed into a liquid form and removed to obtain a high concentration of CO₂. The reduction reaction of the oxygen carrier particle by CH₄ is an endothermic reaction, wherein a heat may be supplied by a high temperature of oxygen carrier particle that is inlet from the air reactor, thus involving no additional energy supply.

Fuel Reactor: Endothermic Reaction

4NiO+CH₄→4Ni+CO₂+2H₂O ΔH⁰₂₉₈=156.2 kJ (14)

A carbon dioxide reduction reactor 30 may be configured to include an oxygen carrier particle supply portion 31, a carbon dioxide inlet portion 32, a carbon monoxide discharge portion 33 and an oxygen carrier particle discharge portion 34. The reduced oxygen carrier particle is supplied to the carbon dioxide reduction reactor 30 and reacted with supplied carbon dioxide to discharge carbon monoxide, and the reduced oxygen carrier particle is partially oxidized and supplied to the air reactor.

Further, the system may further include a carbon dioxide supply line 40 that connects the outlet portion 23 of the fuel reactor and the carbon dioxide inlet portion 32 of the carbon dioxide reduction reactor 30. Accordingly, carbon dioxide supplied to the carbon dioxide reduction reactor 30 is one in which H₂O was removed from a gas discharged from the fuel reactor with a condenser 41.

That is, in the fuel reactor 20, NiO is reacted with CH₄ to be reduced into Ni, and reduced Ni is moved to the carbon dioxide reduction reactor 30. In the carbon dioxide reduction reactor 30, as seen in following Formula (15), Ni reduced in the fuel reactor 20 is reacted with CO₂ to generate CO and Ni is partially oxidized into NiO.

CO₂ Reduction Reactor: Endothermic Reaction

Ni+CO₂→NiO+CO ΔH⁰₂₉₈=43.3 kJ (15)

The whole reaction equation of CLC-CDR technology is as following Formula (16) and becomes equal to a partial oxidation of CH₄. Further, the reaction of Formula (16) is an exothermic reaction, allowing a spontaneous reaction. That is, as adding the oxidation reaction of the oxygen carrier particle that is an exothermic reaction as Formula (13) to the RWGS reaction that is an endothermic reaction as Formula (6), the whole reaction equation is converted into an exothermic reaction by partial oxidation as following Formula (16), allowing generating CO without any supplies of energy and hydrogen from the outside and generating steam and electricity by using a high temperature of gas discharged from the air reactor 10.

Whole Reaction Equation: Exothermic Reaction

CH₄+1.5O₂→CO+2H₂O ΔH⁰₂₉₈=−519.6 kJ (16)

As mentioned above, as applying CLC-CDR technology according to the present disclosure, on the contrary to chemical looping combustion that discharges CO₂ and thus requires additional CO₂ storing or converting technology, it is allowable to obtain a useful material, CO, while generating steam and electricity.

In addition, as compared to RWGS and RWGS-CL, it is allowable to use CH₄ as a reducing agent instead of high priced hydrogen, being economical.

Further, air in which oxygen was consumed is discharged from the air reactor 10, a high concentration of CO₂ is inherently separated in the fuel reactor 20, and unreacted CO₂ and a reaction product, CO are discharged from the carbon dioxide reduction reactor 30. Thus, it is allowable to separate a resulting product at low cost as compared to the RWGS reaction.

Further, the whole reaction equation is an exothermic reaction as formula (16) and thus there is an advantageous effect allowing generating CO from a discharged gas while generating steam and electricity by using a high temperature of gas discharged from the air reactor 10.

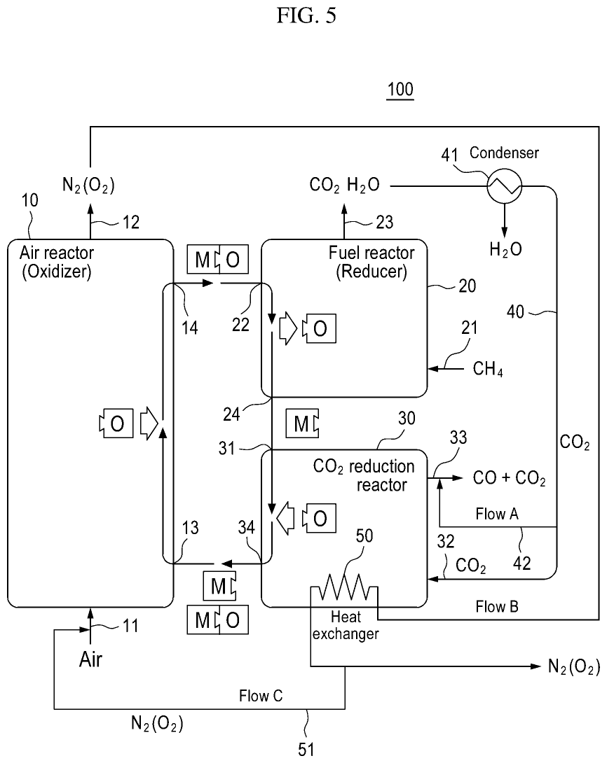

FIG. 5 a conceptual diagram of a chemical looping combustion and carbon dioxide direct reduction (CLC-CDR) integration system showing control functions according to an embodiment of the present disclosure.

As shown in FIG. 5, it is seen that the system may include a first bypass line 42 that is connected in-between one side of a carbon dioxide supply line 40 and the discharge portion 33 of the carbon dioxide reduction reactor. Thus, a part of carbon dioxide discharged from the fuel reactor 20 through the first bypass line 42 is mixed with a gas discharged from the carbon dioxide reduction reactor 30, allowing controlling a ratio of carbon monoxide and carbon dioxide required for a downstream process. That is, as shown in FIG. 5, it is allowable to control a ratio of carbon monoxide and carbon dioxide required for the downstream process in a manner of mixing a part of carbon dioxide discharged from the fuel reactor 20 with a gas discharged from the carbon dioxide reduction reactor 30 (Flow A).

Further, in an embodiment of the present disclosure, the system may be configured to include a heat exchanger 50 that heats the carbon dioxide reduction reactor 30 by using a heat of a gas discharged from the air reactor 10 as a heat source. Thus, a high temperature of gas discharged from the air reactor 10 is supplied to the heat exchanger 50 fitted to the carbon dioxide reduction reactor 30, allowing supplying a heat required in the carbon dioxide reduction reactor 30. That is, as shown in FIG. 5, the carbon dioxide reduction reactor is of an endothermic reaction. Accordingly, it is allowable to supply energy required in the carbon dioxide reduction reactor 30 by using, as a heat exchange fluid, a high temperature of gas discharged from the air reactor 10 that is of an exothermic reaction (Flow B), thus involving no additional discharging of CO₂ during the energy supply to the CO₂ reduction reactor 30.

In addition, in an embodiment of the present disclosure, the system includes a second bypass line 51 that connects between a rear end of the heat exchanger 50 and the air injection portion 11 of the air reactor, allowing supplying a gas discharged from the air reactor 10 to the air injection portion 11 of the air reactor.

That is, in order to increase a reduction state of an oxygen carrier particle that is inlet to the carbon dioxide reduction reactor 30, it is allowable to use a gas discharged from the air reactor 10 (air in which a part of oxygen was consumed, showing a low oxygen concentration as compared to the air), instead of injecting air into the air reactor 10. As shown in FIG. 5, an oxidation-reduction state of an oxygen carrier particle may be controlled by recycling a gas discharged from the air reactor 10 (Flow C) and using the recycled gas instead pure air, or mixing it with pure air and using a mixture thereof. Further, when recycling the gas discharged from the air reactor 10 as the above to the air reactor 10, the temperature thereof is higher than that of air in the atmosphere, allowing enhancing thermal efficiency of the air reactor 10.

Further, the configuration and method of the embodiments as described above are not restrictively applied to the aforementioned apparatus and method. The whole or part of the respective embodiments may be selectively combined so as to make various modifications of the embodiments.

### FIGURE REFERENCE NUMBERS

10: an air reactor
11: an air injection portion
12: a gas discharge portion
13: an oxygen carrier particle supply portion
14: an oxygen carrier particle outlet portion
20: a fuel reactor
21: a fuel supply portion
22: an oxygen carrier particle inlet portion
23: an outlet portion
24: an oxygen carrier particle discharge portion
30: a carbon dioxide reduction reactor
31: an oxygen carrier particle supply portion
32: a carbon dioxide inlet portion
33: a carbon monoxide discharge portion
34: an oxygen carrier particle discharge portion
40: a carbon dioxide supply line
41: a condenser
42: a first bypass line
50: a heat exchanger
51: a second bypass line
100: a chemical looping combustion and carbon dioxide direct reduction (CLC-CDR) integration system

1. A chemical looping combustion and carbon dioxide direct reduction (CLC-CDR) integration system comprising:
an air reactor, wherein an oxygen carrier particle is oxidized by reacting with injected air and air from which oxygen was partially removed is discharged;
a fuel reactor, wherein the oxidized oxygen carrier particle is supplied, a supplied fuel is reacted to reduce the oxidized oxygen carrier particle, and carbon dioxide including H₂O is discharged; and
a carbon dioxide reduction reactor, wherein the reduced oxygen carrier particle is supplied, supplied carbon dioxide is reacted to discharge carbon monoxide, and the reduced oxygen carrier particle is partially oxidized and supplied to the air reactor.

2. The chemical looping combustion and carbon dioxide direct reduction (CLC-CDR) integration system of claim 1, comprising
a carbon dioxide supply line that connects an outlet portion of the fuel reactor and the carbon dioxide reduction reactor, wherein
carbon dioxide supplied to the carbon dioxide reduction reactor is one in which H₂O was removed from a gas discharged from the fuel reactor.

3. The chemical looping combustion and carbon dioxide direct reduction (CLC-CDR) integration system of claim 2, wherein
the air reactor is of an exothermic reaction (oxidizer), the fuel reactor is of an endothermic reaction (reducer), the carbon dioxide reduction reactor is of an endothermic reaction and the whole system is of an exothermic reaction, and
steam or electricity is generated by a heat discharged from the air reactor.

4. The chemical looping combustion and carbon dioxide direct reduction (CLC-CDR) integration system of claim 2, comprising
a first bypass line that is connected in-between one side of the carbon dioxide supply line and a discharge portion of the carbon dioxide reduction reactor, wherein
a ratio of carbon monoxide and carbon dioxide required for a downstream process is controlled by mixing a part of carbon dioxide discharged from the fuel reactor with a gas discharged from the carbon dioxide reduction reactor.

5. The chemical looping combustion and carbon dioxide direct reduction (CLC-CDR) integration system of claim 4, further comprising
a heat exchanger that heats the carbon dioxide reduction reactor by using a heat of a gas discharged from the air reactor as a heat source.

6. The chemical looping combustion and carbon dioxide direct reduction (CLC-CDR) integration system of claim 5, comprising
a second bypass line that connects between a rear end of the heat exchanger and an air injection portion of the air reactor, wherein
a gas discharged from the air reactor is supplied to the air injection portion of the air reactor.

7. The chemical looping combustion and carbon dioxide direct reduction (CLC-CDR) integration system of claim 6, wherein
a mixing ratio of air and a gas discharged from the air reactor is adjusted to control an oxidation-reduction state of the oxygen carrier particle.

8. An operation method of a chemical looping combustion and carbon dioxide direct reduction (CLC-CDR) integration system comprising steps of:
reacting air injected into an air reactor and an oxygen carrier particle to oxidize the oxygen carrier particle, and discharging air from which oxygen was partially removed;
supplying the oxidized oxygen carrier particle to a fuel reactor, reacting a supplied fuel to reduce the oxidized oxygen carrier particle, and discharging carbon dioxide including H₂O; and
supplying the reduced oxygen carrier particle to a carbon dioxide-reactor, supplying carbon dioxide in which H₂O was removed from a gas discharged from the fuel reactor to discharge carbon monoxide, and partially oxidizing the reduced oxygen carrier particle to be supplied to the air reactor.

9. The operation method of a chemical looping combustion and carbon dioxide direct reduction (CLC-CDR) integration system of claim 8, further comprising a step of:
generating steam or electricity by a heat discharged from the air reactor.

10. The operation method of a chemical looping combustion and carbon dioxide direct reduction (CLC-CDR) integration system of claim 8, further comprising a step of:
mixing a part of carbon dioxide that is discharged from the fuel reactor through a first bypass line connected in-between one side of a carbon dioxide supply line and a discharge portion of a carbon dioxide reduction reactor, with a gas discharged from the carbon dioxide reduction reactor, to control a ratio of carbon monoxide and carbon dioxide required for a downstream process.

11. The operation method of a chemical looping combustion and carbon dioxide direct reduction (CLC-CDR) integration system of claim 10, further comprising a step of:
supplying a gas discharged from the air reactor to a heat exchanger fitted to the carbon dioxide reduction reactor to heat the carbon dioxide reduction reactor.

12. The operation method of a chemical looping combustion and carbon dioxide direct reduction (CLC-CDR) integration system of claim 11, further comprising a step of:
supplying a gas discharged from the air reactor to an air injection portion of the air reactor through a second bypass line that connects between a rear end of the heat exchanger and the air injection portion of the air reactor.

13. The operation method of a chemical looping combustion and carbon dioxide direct reduction (CLC-CDR) integration system of claim 12, wherein
a mixing ratio of air and a gas discharged from the air reactor is adjusted to control an oxidation-reduction state of the oxygen carrier particle.
